(19) United States
(12) Patent Application Publication
(10) Pub. No.: US 2016/0097220 A1
(43) Pub. Date: Apr. 7, 2016

(54) Cabinet Locking Device Using an Electromagnetic Switch Actuated System with Fingerprint Identification, Combination Code and Bluetooth System

(71) Applicant: Yiqi Wu Woodling, Carmel, IN (US)

(72) Inventor: Yiqi Wu Woodling, Carmel, IN (US)

(21) Appl. No.: 14/504,372

(22) Filed: Oct. 1, 2014

(51) Int. Cl. E05B 47/00; E05C 3/04; E05C 3/02

(52) U.S. Cl. CPC E05B 47/0001; E05C 3/02; E05C 3/041

(57) ABSTRACT

A keyless lock system includes not only an electromagnetic switch system, a fingerprint identification system, but also included a combination code system though a Bluetooth wireless connection to a smart phone or external device. The electromagnetic switch system can secure a cabinet or any lock. The system can mainly be secured by the force and vibration from outside of cabinet. The fingerprint identification provides the lock device an easy operation without a key. The combination code can be used on the device of the keypad and used on the smartphone though a wireless Bluetooth connection. The combination code can be reset by smart phone or external device. A changeable battery and power supply system will keep the system information at date without losing the memory if the system lost power.

This application claims the benefit of my early filed Provisional Application # U.S. 61/896,059: filed on Oct 26, 2013.

### BACKGROUND OF THE INVENTION

1. Field of the Invention

The present invention is directed to the cabinet locking system using with the fingerprint identification, combination code and Bluetooth system. The cabinet locking system can be a container with a lock device. The invention is mainly on a user interface of a lock device with fingerprint identification, combination code system and wireless Bluetooth connection system though a smart phone or external device. It is an attachable lock device to a container.

2. Description of Related Art

The mechanical locker system operates using key or a combination code. People have to carry the key to operate the locker or cabinet. The combination system is a problem to challenge the people's memory. The cabinet unit cannot be operated if the key is lost or the combination number is forgotten.

The electronic locker system uses a tag or a card to open the cabinet. People have to wear or carry the tag or the card to open the locker.

The single magnetic switch system was easy unlocked by the external force or vibration. It required the heavy duty system or a motor system.

The fingerprint locking system uses people's finger to open the locking device. The applied fingers can open the locker as many times as it applied. It can open the locker by using combination code though the buttons at the front of case. It also can be used with the smartphone or external device to manage the fingerprint and combination code though the wirelesses of Bluetooth signal.

The dual electromagnetic switch system will not be effect by external force and vibration force.

### SUMMARY OF THE INVENTION

The present invention provides a multiply user interface system of a lock device for the cabinet or container. It is a particular object of the present invention to the lock device can be accessed the fingerprint and combination code though the fingerprint sensor and buttons. More particularly, in the present invention the locking device has a fingerprint identification and combination code system though a Bluetooth wireless connection by using smartphone or external device to manager the same identification of fingerprint and combination code installed. It is also another particular object of the present invention to provide a dual electromagnet switch with an actuated structure to the cabinet or container. The dual electromagnetic switch system design can against the external force and vibration force.

### BRIEF DESCRIPTION OF THE DRAWINGS

FIG. 1 shows a perspective view of a locking device which contains the user interface portion, lock mechanism and electrical executive system.

FIG. 2 shows operation components on the user interface area.

FIG. 3 is a diagram of main microprocessor IC with combination code and Bluetooth application software

FIG. 4 shows a locking device assemble to a door panel of a cabinet.

FIG. 5 shows a detailed locking device assemble at the inside of locking case.

FIG. 6 is a diagram of the cabinet locking system.

### DETAILED DESCRIPTION OF PREFERRED EMBODIMENTS

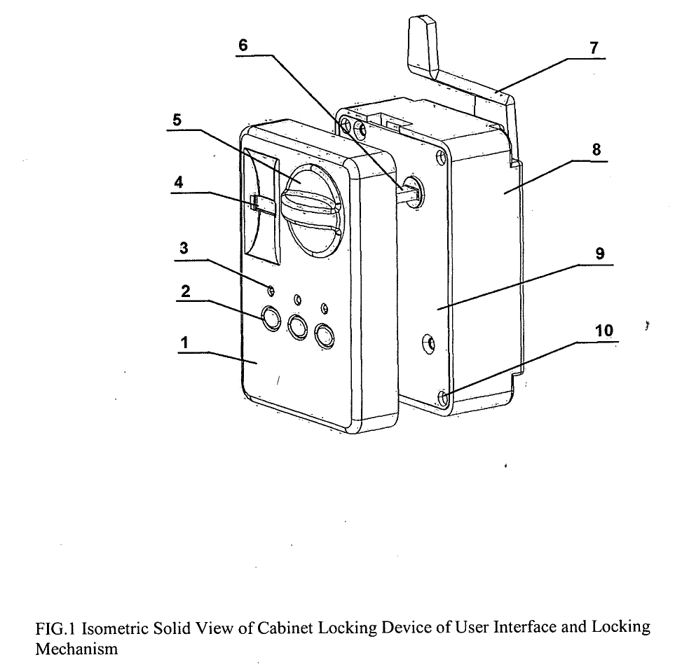

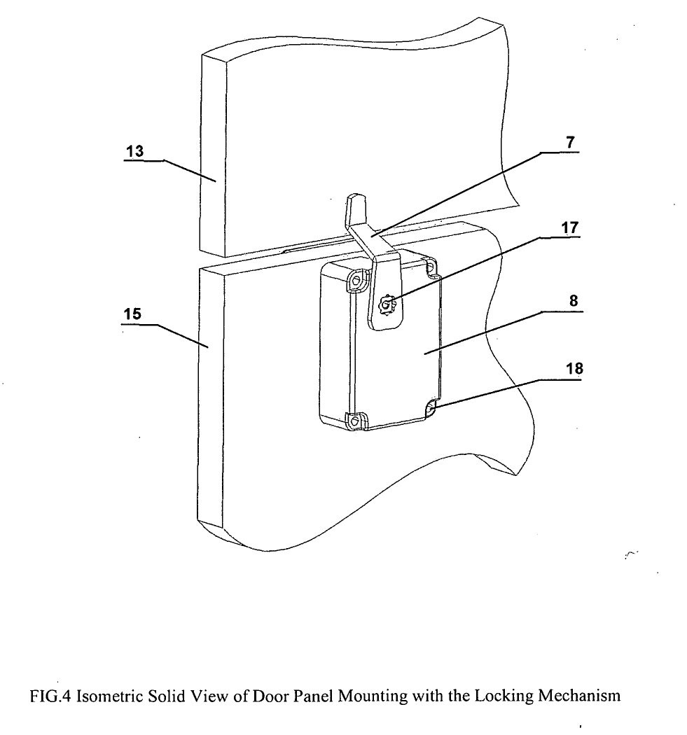

FIG. 1 shows a perspective view of a cabinet locking system. This cabinet locking system contains a user interface portion, a locking mechanism and a dual electromagnetic switch system. The user interface system serves as either a fingerprint identification system or a combination code system or a Bluetooth connection though a smartphone system. FIG. 1 has shown the user interface portion installed at the front of the cabinet or outside of a cabinet. The user interface portion has the front case 1 which has digits action buttons 2 and LEDs 3. LED 3 is used to indicate the application status when button 2 is operated. The user interface portion also contains a fingerprint sensor 4 which can scan fingerprints after the device is turned on by pressing the buttons 2. The locking device will calculate and compare the image of the fingerprint scanned with that of the fingerprint preinstalled. It will make an execution if the images are matched. After the LED 3 indicate a success of the matching of the fingerprints, the user can use the knob or lever 5 to lock or unlock the cabinet though the locking mechanism. At the same time the dual electromagnetic switch system will be operated by the locking block 24 and active block and spring 25 to a disc 23 at a lock or unlock position. The axle core 6 will transfer the actuated force to the locking mechanism from the knob or lever 5. The lock cam 7 is an attached part with the core 6 to make the cam 7 at a locking or unlocking position to the frame 13 at the door panel 15. The case 8 contains a locking mechanism with the case cover 9 and it is secured with the screws 10, see detail at FIG. 4

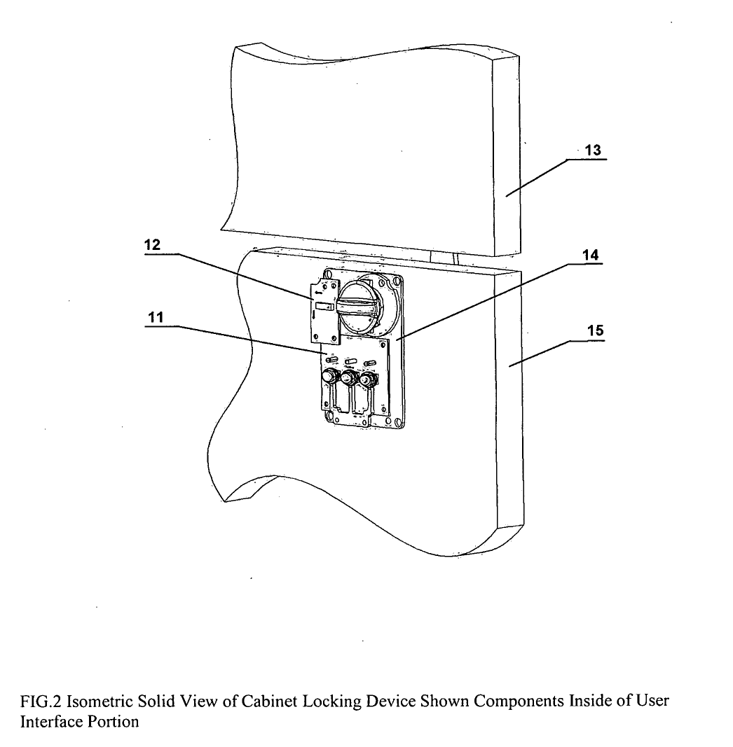

FIG. 2 shows the components inside of the user interface portion. The major component is PCB 11 which has the microprocessor IC 31 to calculate and process the image read from the sensor 4 mounted on a sensor panel 12. The sensor panel 12 will be mounted to the user interface case 1. The door frame 13 can be locked by cam 7 to make the cabinet locked completely. The door panel 15 is mounted between the user interface case 1 and locking mechanism case 8. The user interface case cover 14 is mounted to the case 1 with the screws.

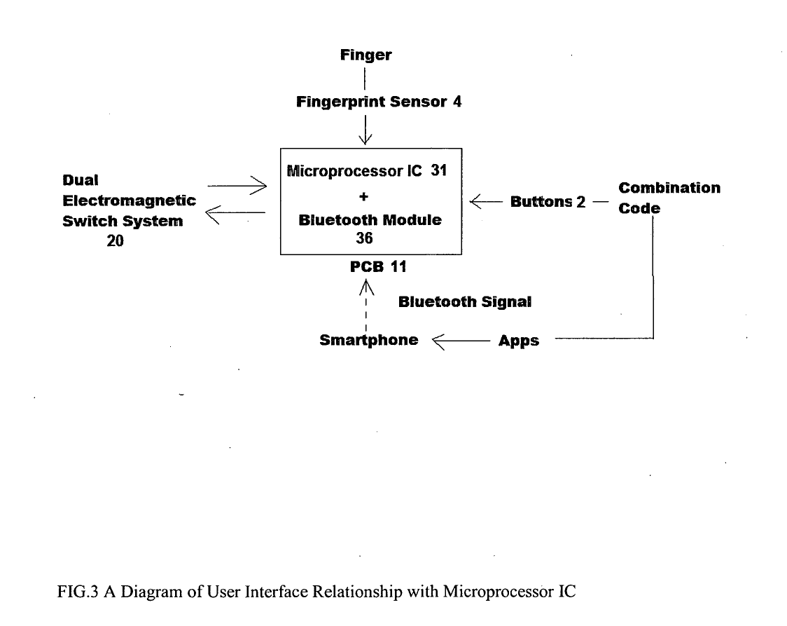

FIG. 3 is a diagram of microprocessor IC 31 on PCB 11 with the combination code and Bluetooth application. The IC 31 on PCB 11 has user interface software to match the combination number installed with the imported number from the buttons 2. If the numbers matched, the locking system will be at the unlocking position. If the numbers unmatched, the locking system will keep at the locking position. The PCB 11 also contains a Bluetooth module 36 which will be looking for the wireless matching source signal from the Bluetooth matching signal of a smart phone. The source signal has to relate with the combination number installed into the IC 31. Each lock can be install own source name. The smart phone can search each different lock. The Bluetooth matching signal on the smart phone can be installed though the application software. The IC 31 will act with dual electromagnetic switch 20 system to operate the locking device on a locking and unlocking position. The IC 31 on PCB 11 also can match the fingerprint installed by the fingerprint sensor of smart phone with application software installed to the smart phone to open the lock.

A combination code will be created by random code software and installed into the main IC 31 though the USB connection. The matching combination code during the operation will be imported though the button 2 action and LED 3 indication. The sensor 4 module will be directly connected to the main IC 31. The main IC 31 will read and install the fingerprint to the memory. It also compares the fingerprints to make the command to the dual electromagnetic switch 20.

The combination code installed on the IC 31 has a connection to a source code of Bluetooth module 36 though a software.

A smart phone or external device can find the Bluetooth signal of the source code name from the lock device when the signal becomes a reach distance. It will show the source name on the list of the phone. Then the user can press the button on lock to pair the signal. It creates a wireless connection though the Bluetooth module between the lock and the smart phone or external device.

Application software has to install into the smart phone or external device. The software has the user interface function of reset the combination code. Combination code can open the lock when the user imported code is matching with the initial code.

It also can use the fingerprint sensor of smart phone or external device to read and manage the fingerprint to the microprocessor IC 31 though a wireless connection.

When the fingerprint matched though smart phone or external device, the unlock sign on the phone or external device should turn on. The user can point the unlock sign on the screen of device to open the lock.

FIG. 4 shows a perspective view of the locking mechanism which uses the locking mechanism case 8 with the lock cam 7 to attach with the door panel 15. It should be installed at the behind of cabinet door panel 15. The cam 7 has to be mounted on the axle core 6 and locking case 8 with the nut 17 locked tightly. The screws 18 make the locking mechanism case 8 and case cover 19 secure with the door panel 15.

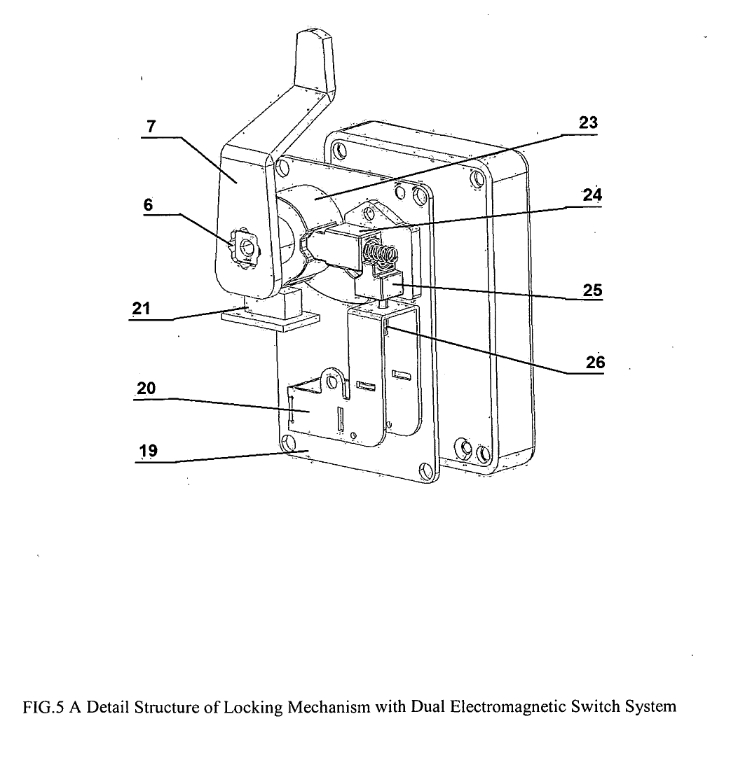

FIG. 5 shows a detailed operation system of locking mechanism and dual electromagnetic switch system. The locking mechanism operated by a dual electromagnetic switch system 20, which controls the return switch system, and dual electromagnetic switches. The dual electrical magnetic switch system 20 can be referenced by the patent no. U.S. Pat. No. 8,353,187. The return switch system contains a return switch 21, active block and spring 22, and a disc 23 acting with the dual electromagnetic switch system 20.

After the scanned fingerprint matching the fingerprint pattern installed, the device can be unlocked. The major magnetic actuator 26 with the actuator block 25 will be moved away by the electrical signal from the locking block 24, the locking block and spring 24 will react and moved away from the disc 23. Then the knob or lever 5 can turn the disc 23 to an unlocking position. At the same time, the actuate arm on disc 23 will be released from the active block and spring 22. The locking device is at an unlocking position.

If the device needs to be locked, the lock cam 7 has to be moved to the locking position by the knob or lever 5. The actuate arm on disc 23 will act on the active block and spring 22 and return switch 21. It will give the electrical signal to the dual electromagnetic switch system 20. The major magnetic actuator 26 moves to a locking position with the actuator block 25. At the same moment, the disc 23 driven by the axle core 6 and the knob or lever 5 to the locking position fits with the locking block 24 in the notch. It creates a locking mechanism. A disc 23 had an actuate arm and notch acting with the dual electromagnetic switch system between a locking and an unlocking position to control the device at a locking or an unlocking status.

The axle core 6 will transfer the external force from the knob or lever 5 to a disc 23 and to a lock cam 7 or a latch or bolt locking part. These components operate together as a locking mechanism.

The locking mechanism is acted with the dual electromagnetic system and the knob or lever 5.

The locking mechanism will move to an unlocking position after the fingerprint identified and the knob or lever 5 is turning to an unlock direction.

The cabinet lock system can be operated by portable battery and lower voltage power supply.

The power supply can be located inside Or outside of cabinet.

The cabinet locking device can be used on the container or a locking system with the door and latch system.

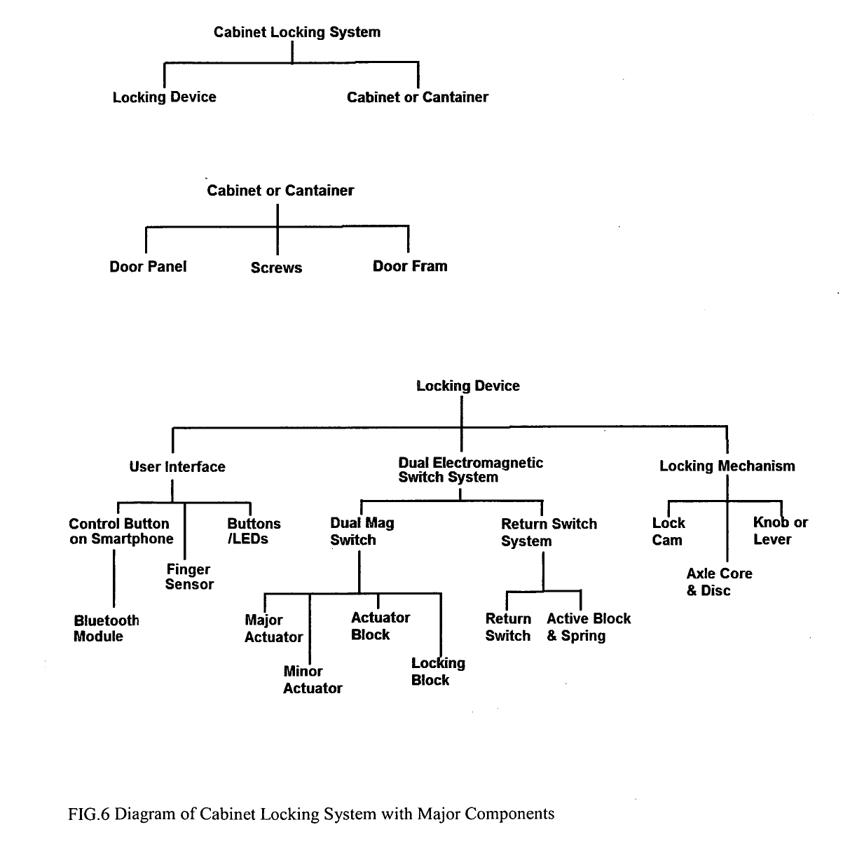

FIG. 6 is a diagram of Cabinet Locking System. The cabinet locking system contains a locking device and a cabinet or container. The locking device composed a user interface, a dual electromagnetic switch system and a locking mechanism. The user interface combined a fingerprint, combination code and smartphone operation though Bluetooth signal. The dual electromagnetic switch system contains the active dual magnet switch and return switch system. The locking mechanism used knob or lever to perform the lock cam a locking or unlocking position though an axle core and locking disc after interactive with the dual electromagnetic switch system. A cabinet or container contains a door panel and door frame. The screws will mount the user interface case at the front of cabinet. The dual electromagnetic switch system and locking mechanism will be mounted inside of cabinet.

What is claimed is:

1. A lock comprising:
(A) a locking mechanism case body
(B) a locking mechanism switching between a locking position and an unlocking position and including a locking part, a disc and a knob or lever mounted on an axle core;
(C) a locking block connected to the case body with a spring switching between an immobile state in which the locking mechanism is immobile in a locking position and a mobile state in which the locking mechanism is mobile under an external force;
(D) a major electromagnetic switch system controlling the movement of the locking block and including
(1) a body comprising a solenoid and a magnet;
(2) an actuator movable inside the solenoid between a first actuator position in which the locking block is immobilized and a second actuator position in which the locking block is mobile;
(3) an actuator block mounted flexibly on the actuator of the major electromagnetic switch stabilizing the locking blocking and reducing the force from the locking block on the actuator of the major switch;
(E) a minor electromagnetic switch system including
(1) a solenoid body;
(2) a rod movable inside the solenoid;
(3) a stop plate mounted on the case body, and the slot of the stop plate floated on the rod of the minor electromagnetic switch with a spring;
the stop plate is movable between a first plate position in which the actuator of the major electromagnetic switch system is immobilized and a second plate position in which the actuator of the major electromagnetic system is mobile;
(F) a return switch applies a locking signal to the major electromagnetic switch when acted by the disc;
(G) a power source from which the power should be shut off if no operation within a predetermined amount of time.

2. The lock as claimed in claim 1 wherein the locking part can be a cam, a latch or a bolt.

3. The lock as claimed in claim 1 wherein the disc has an actuate arm and a notch acting with the major electromagnetic switch to control the lock at a locking or an unlocking status.

4. The lock as claimed in claim 1 wherein the axle core transfers the force from the knob or lever to the locking part and the disc.

5. The lock as claimed in claim 1 wherein after receiving a locking signal, the actuator of the major electromagnetic switch moves to the first actuator position in which the stop plate of the minor electromagnetic switch is sprung into the first plate position under the end of the actuator of the major electromagnetic switch to block the movement of the actuator of the major electromagnetic switch.

6. The lock as claimed in claim 1 wherein after receiving an unlocking signal, the rod of the minor electromagnetic switch pulls the stop plate to the second plate position in which the actuator of the major electromagnetic switch moves to the second actuator position; the blocking block with a spring forcing against the disc at vertical direction is mobile and the knob or lever can be acted by an external force to turn the disc to an unlocking position though an axle core.

7. The lock as claimed in claim 1 wherein the actuator block has a flexibly connection with the actuator of the major electromagnetic switch and follows the movement of the actuator of the major electromagnetic switch.

8. The lock as claimed in claim 1 wherein the return block switching between an immobile state in which the knob or lever, the locking part and the disc are immobilized and a mobile state in which the knob or lever , the locking part and the disc are mobile under an external force.

9. The lock as claimed in claim 1 wherein the power source includes alkaline batteries locating in an isolated compartment of the case body and external power supply connected to the main board.

10. The lock as claimed in claim 1 being a cabinet lock, safety box lock, door lock, or draw lock.

11. The lock as claimed in claim 1 further comprising: a fingerprint or combination code user interface operable whether the locking part and the disc are at a locked position or an unlocked position and including
(A) an user interface case body;
(B) a fingerprint sensor;
(C) operating buttons;
(D) LED's for indication of fingerprint installation, locking status, power on/off status or low battery status;
(E) memory portion for storing registered fingerprints or combination codes;
(F) a microprocessor IC comparing the input fingerprint or combination code with the registered fingerprints or combination codes;
(G) a user interface software operation system for the microprocessor IC.
(H) a software created a random code will be a combination code and install into the microprocessor IC.
(I) user interface software and random code software can install to microprocessor IC with a USB connection.

12. The lock as claimed in claim 11 further comprising:
(A) a Bluetooth module connected to the microprocessor IC on main PC board of the user interface;
(B) an application software for a smart phone or other external control device which can be connected wirelessly to the user interface via the Bluetooth module.
(C) an application software can install the fingerprint by using the fingerprint sensor on the smart phone or an external control device.
(D) an application software can read the fingerprint and compare with the existing fingerprint on smart phone or external device though the microprocessor IC; if both matches, the lock can open; if both not match, the lock cannot open.

13. The lock as claimed in claim 11 wherein
(A) an unlocking signal applies to the minor electromagnetic switch if the input fingerprint matches the stored fingerprints in the memory or the input combination code matches the combination codes in the memory; then after a predetermined amount of time, an unlocking signal applies to the major electromagnetic switch as well;
(B) a locking signal applies to the major electromagnetic switch when the return switch is acted by the disc through the return actuator;
(C) a locking or unlocking signal is turned off after a predetermined time to save energy.

14. The lock as claimed in claim 11 wherein the replacement of the power source does not affect the installed fingerprints or combination codes.

15. The lock as claimed in claim 11 wherein the operating buttons functioning as the control for fingerprint installation and management.

16. The lock as claimed in claim 11 wherein the operating buttons functioning as the control for combination code installation and management.

17. The lock as claimed in claim 11 wherein
(A) Additional fingerprint or combination code can be installed after administrator fingerprint has been verified;
(B) The stored fingerprint or combination code can be deleted after administrator fingerprint has been verified.

18. The lock as claimed in claim 11 wherein
(A) the user interface is installed on the outside of the cabinet door;
(B) the major and minor electromagnetic switch systems, the disc are enclosed in the locking mechanism case body which is secured on the inside of the cabinet panel by screws;
(C) the knob or lever residing on the front surface of the user interface case body is used to apply the unlocking force after the indication of the match of fingerprint or combination code and to apply the locking force when needed;
(D) the axle core connects the user interface case body mounted on the outside of the cabinet panel and the locking mechanism case body mounted on the inside of the cabinet panel, and transfers the locking or unlocking force from the knob or lever to the disc system.

19. The lock as claimed in claim 12 wherein
(A) a Bluetooth source signal has connection to each lock;
(B) each lock has own Bluetooth source signal connection.
(C) searching for a matching code by the Bluetooth module can be done by pressing the button on the user interface. LED will indicate the matching status;

20. The lock as claimed in claim 12 wherein
(A) the lock manufacturer will provide application software to be installed on the smart phone or external device;
(B) the application software can reset the combination code on the smart phone or external device;
(C) if the combination code on smart phone matches, the lock will open; if the code not matches, the lock will not open. (D) the application software on smart phone or external device can communicate with the lock body though a Bluetooth connection;
(E) the smart phone and external device can manage the fingerprint installation and application though the fingerprint sensor. (F) the smart phone or external device can operate the locking system as a wireless user interface.
